(19) United States
(12) Patent Application Publication
(10) Pub. No.: US 2013/0227642 A1
(43) Pub. Date: Aug. 29, 2013

(54) APPARATUS AND METHOD FOR DETECTING ILLEGAL USER

(71) Applicant: Electronics and Telecommunications Research Institute, (US)

(72) Inventors: Sung June CHANG, Daejeon (KR); Hun Joo LEE, Daejeon (KR); Yeon Jun CHOI, Daejeon (KR); Ju Young KIM, Daejeon (KR); Dongchun LEE, Daejeon (KR); Hang Kee KIM, Daejeon (KR); Chang Joon PARK, Daejeon (KR)

(73) Assignee: Electronics and Telecommunications Research Institute, Daejeon (KR)

(21) Appl. No.: 13/780,282

(22) Filed: Feb. 28, 2013

(30) Foreign Application Priority Data
Feb. 29, 2012 (KR) 10-2012-0021190
Jul. 23, 2012 (KR) 10-2012-0080152

(51) Int. Cl. G06F 21/31

(52) U.S. Cl. CPC G06F 21/316
USPC 726/2

(57) ABSTRACT

An apparatus for detecting an illegal user includes a user characteristics analysis unit configured to analyze difference of unique characteristics between an illegal program and a normal user; and a recognition method determination unit configured to determine a recognition method for recognizing the illegal program on the basis of the difference of the unique characteristics. Further, the apparatus for detecting the illegal user includes an illegal user detection unit configured to detect the illegal user using the illegal program within a game by the recognition method.

### CROSS-REFERENCE TO RELATED APPLICATIONS

The present invention claims priority of Korean Patent Application No. 10-2012-0021190, filed on Feb. 29, 2012, and Korean Patent Application No. 10-2012-0080152, filed on Jul. 23, 2012, which are incorporated herein by references

### FIELD OF THE INVENTION

The present invention relates to detecting an illegal user; and, more particularly, to an apparatus and a method for detecting an illegal user, which are secure in a game bot or an auto program and the like which are changeable.

### BACKGROUND OF THE INVENTION

According to the development of communication networks and computer-related technologies, the various kinds of online gaming services are being offered.

Most of the online games progress by using many game items capable of functioning specially in the game. Although the game items exist in virtual space, without existence, many users want to possess the game items or the game items not obtained easily have high asset value.

Therefore, in order to obtain the game items with high asset value, the cases of fraudulently using the game have appeared. One of them is to play the game by using a robot program (called illegal user or ‘GAME BOT’).

The robot program may be made by the modulation/alteration of a game client, and plays the game abnormally such as obtaining the game items and the like by pretending that itself is a user and continuously confronting a NPC (Non Player Character) for itself within the game according to the content of programming.

Aside from this example, the case of fraudulently using an online game has been being continuously various according to the increase of asset value within the game.

Accordingly, much damage such as normal game users unreasonably forfeiting an opportunity to get good items and disturbance of playing a game and the like may occur, which may avoid using a game and be a major factor in causing complaints by decreasing interest in a game.

A method for detecting an illegal user within a game as above is a way of selecting and monitoring a related auto program by analyzing a log generated through a game bot or an auto program.

But, this method has a disadvantage that because sufficiently collecting the log of a game bot or an auto program is needed to select an illegal user, the illegal user may be select after the damage caused by a game bot or an auto program occurs, and, even if the illegal user is detected, has a problem that it is difficult to find the illegal user again if a game bot or an auto program are modified just a little. Particularly, in case of the game bot or the auto program which are editable, there is a problem that it is difficult to find an illegal user by the method described above.

Further, there is a problem that a prior method has a difficulty in actively coping with a game bot and an auto program because a prior method manages a game bots or an auto program in the level of simply monitoring.

### SUMMARY OF THE INVENTION

In view of the above, the present invention may provide an apparatus and method for detecting an illegal user, which is secure in the change of a game bot or an auto program by detecting an illegal user, based on analyzing the difference of unique characteristics between an actual user and an auto program through analysis of the user characteristics.

Further, the present invention may provide an apparatus and method for detecting an illegal user, which is not simple monitoring of an illegal user but capable of actively managing by detecting and managing according to recognition of an illegal user.

In accordance with a first aspect of the present invention, there is provided an apparatus for detecting an illegal user, including: a user characteristics analysis unit configured to analyze difference of unique characteristics between an illegal program and a normal user; a recognition method determination unit configured to determine a recognition method for recognizing the illegal program on the basis of the difference of the unique characteristics; and an illegal user detection unit configured to detect the illegal user using the illegal program within a game by the recognition method.

Further, the user characteristics analysis unit may analyze the difference of the unique characteristics on the basis of the characteristics of the illegal program and a game log data of the normal user.

Further, the illegal user detection unit may extract a user on the basis of the recognition method and register the extracted user in a candidate group, and may detect the illegal user using the illegal program within the candidate group on the basis of the game log data of the user within the candidate group and the recognition method.

Further, the illegal user detection unit may further comprise a verification unit configured to determine whether each user uses an illegal program based on the game log data of the user within the candidate group and then perform verification of the recognition method on the basis of the determination result.

Further, the apparatus may further comprise a detection result responding unit configured to perform analysis and reporting of the game log data of the detected illegal user.

Further, the apparatus may further comprise a detection result tracking unit configured to track the illegal user through collecting the game log data of the detected illegal user.

Further, the apparatus may further comprise a verification unit configured to perform verification of the recognition method using a predetermined reference data

In accordance with a second aspect of the present invention, there is provided a method for detecting an illegal user, including: analyzing difference of unique characteristics between a user using an illegal program and a normal user; determining a recognition method for recognizing the illegal user on the basis of the difference of the unique characteristics; and detecting the illegal user using the illegal program within a game on the basis of the determined recognition method.

Further, said analyzing difference of unique characteristics may include after obtaining unique characteristics information of the normal user and a user using the illegal program on the basis of a game log data of the normal user and the user using the illegal program, analyzing the difference of the unique characteristics using the obtained unique characteristics information.

Further, said detecting the illegal user may include extracting a user on the basis of the recognition method and then registering the extracted user in a candidate group; and detecting the illegal user using the illegal program within the candidate group on the basis of the game log data of the user within the candidate group and the recognition method.

Further, the method may further comprise determining whether each user uses an illegal program is on the basis of the game log data of the user registered in the candidate group, and then performing verifying the recognition method on the basis of the determination result.

Further, the method may further comprise analyzing and reporting the game log data of the detected illegal user.

Further, the method may further comprise performing tracking the illegal user through collecting the log data of the illegal user.

Further, the method may further comprise performing verifying the recognition method on the basis of the predetermined reference data, and said detecting the illegal user using the illegal program may be performed such that the illegal user is detected on the basis of the verified recognition method.

In accordance with the present invention, it is possible to provide an apparatus and a method, which are capable of coping with the change of a game bot or an auto program, securely detecting in an unknown game bot or auto program and continuously and minutely tracking the game bot or auto program by detecting an illegal user using the difference of unique characteristics between a normal user and the game bot or auto program.

### BRIEF DESCRIPTION OF THE DRAWINGS

The objects and features of the present invention will become apparent from the following description of embodiments given in conjunction with the accompanying drawings, in which:

FIG. 1 is a block diagram showing an apparatus for detecting an illegal user in a game in accordance with an embodiment of the present invention;

FIG. 2 is a flow chart showing a process of detecting an illegal user in a game in accordance with an embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, embodiments of the present invention will be described in detail with reference to the accompanying drawings which form a part hereof.

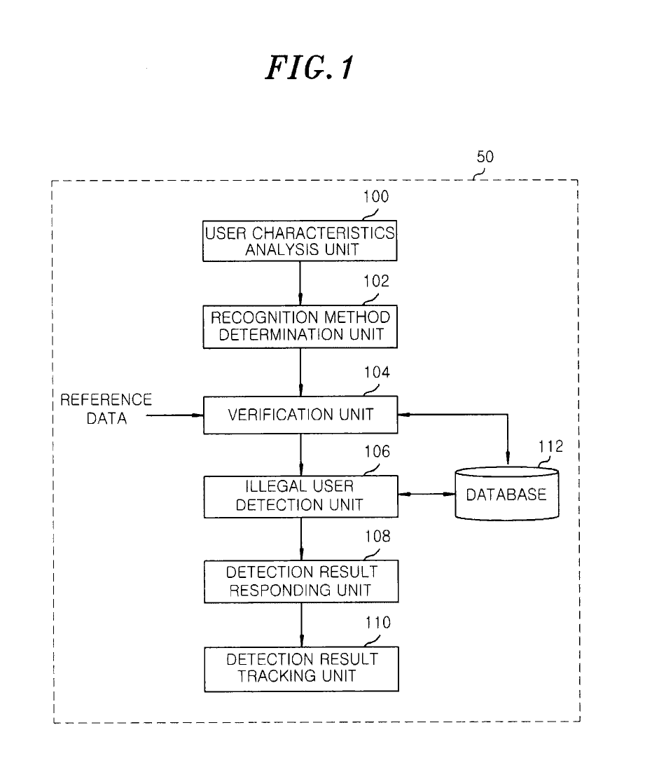

FIG. 1 is a block diagram showing an apparatus for detecting an illegal user in a game in accordance with an embodiment of the present invention. Hereinafter, the configuration and operation of an apparatus for detecting an illegal user will be described in detail with reference to FIG. 1 in accordance with an embodiment of the present invention.

As shown in FIG. 1, an apparatus for detecting an illegal user may generate a method for recognizing an illegal user and detect the illegal user within a game on the basis of the generated method, which is based on the difference of unique characteristics between the illegal and normal user.

The apparatus for detecting an illegal user may include a user characteristics analysis unit 100, a recognition method determination unit 102, a verification unit 104, an illegal user detection unit 106, a detection result responding unit 108, a detection result tracking unit 110, a database 112 and the like in accordance with an embodiment of the present invention.

The user characteristics analysis unit 100 may analyze the difference of unique characteristics between an illegal and normal user through comparing the game data of a character played by a normal user with the game data of a character(illegal user) played by an illegal program such as a game bot or auto program and the like.

As an example of the method for analyzing the difference of unique characteristics, the unique characteristics information of the normal user may be obtained after requiring the log data of a game played by the normal user of an external game sever (not shown) and receiving, and after playing a game for a character by using the illegal user, the unique characteristics information of the illegal user may be obtained by collecting the log data. Then, the difference of unique characteristics may be analyzed through comparing each of the acquired unique characteristics information.

The recognition method determination unit 102 may determine a recognition method for recognizing the illegal user, which is based on the difference of unique characteristics.

The verification unit 104 may perform verification of the recognition method for recognizing the illegal user, which is determined in the recognition method determination unit 102 by using data received from the external e.g., predetermined reference data.

The illegal user detection unit 106 may perceive the illegal user using an illegal program within a game, and register the perceived user as a candidate group in the database 112 according to the method for recognizing the illegal user, which is verified by the verification unit 104.

Further, the illegal user detection unit 106 may detect the illegal user using the auto program or game bot by analyzing the game-related data of the user within the candidate group, i.e., the game log data of a character played by a user of the candidate group within the game, based on the method for recognizing an illegal user.

After determining whether or not each user's using an illegal program is, based on the game log data of the user registered in the candidate group, the verification unit 104 may perform verification of the method for recognizing an illegal user according to the result of the judgment.

The detection result responding unit 108 may perform the analysis and reporting of the illegal user detected within the game, based on the verified method for recognizing an illegal user.

The detection result tracking unit 110 may perform tracking each illegal user within the candidate group through collecting the game log data of the detected illegal user.

As described above, if a the difference of unique characteristics between the normal user and the illegal user using the game bot or auto program and the like is analyzed, and then an illegal user is detected on the basis of the analyzed difference of the unique characteristics, it is possible to securely detect the illegal user even in the game bot or auto program which is changeable or unknown.

Because, unlike the conventional method, the normal or illegal user is distinguished by the difference of the unique characteristics even though the game bot or auto program is changed by editing and the like or an auto program having an unknown pattern appears.

Further, it is possible to cope with the illegal program through collecting the continuous and detailed information of the illegal program by detecting the result of the detection differently from the prior method.

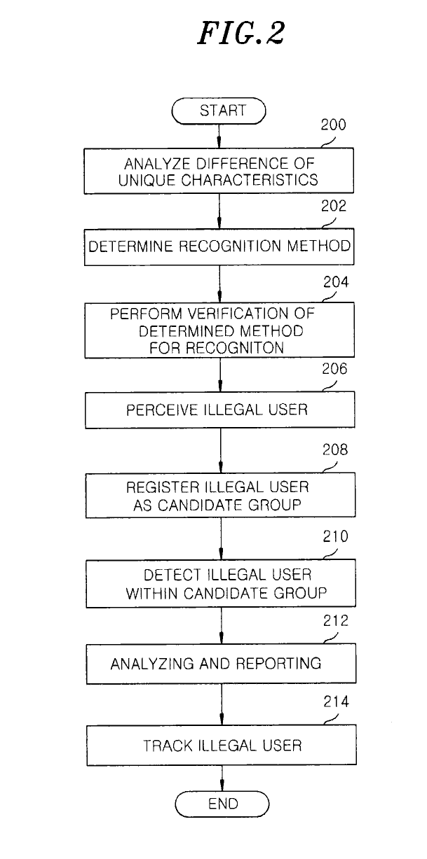

The operation process of the apparatus for detecting an illegal user, which has the same configuration as above, will be described with reference to FIG. 2.

FIG. 2 is a flow chart showing a process of detecting an illegal user in a game in accordance with an embodiment of the present invention.

As shown in FIG. 2, first, the user characteristics analysis unit 100 may receive and analyze the information of a game character; and, particularly, analyze the difference of unique characteristics between the game data of a character played by a normal user within a game and the game data of a character (illegal user) operated by an illegal program such as a game bot or auto program and the like in operation 200.

Next, the recognition method determination unit 102 may determine the method for recognizing an illegal user on the basis of the difference of unique characteristics in operation 202, and the verification unit 104 may perform the verification of the determined method for recognition in operation 204. That is, the verification unit 104 may perform the verification of the method for recognition determined on the basis of the data provided from the external, e.g., a game sever (not shown).

After, the illegal user detection unit 106 may perceive the illegal user using the illegal program within the game by using the verified method for recognition in operation 206, and register the perceived user as a candidate group in the database 112 in operation 208.

Then, the illegal user detection unit 106 may detect the illegal user using the auto program or game bot by analyzing the game-related data of users within the candidate group, i.e., the game log data of the character operated by the user in the candidate group within the game, on the basis of the method for recognizing an illegal user in operation 208.

The detection result responding unit 108 may analyze and perform reporting the result of the detection in the illegal user detection unit 106 in operation 210, the detection result tracking unit 110 may track the illegal user using the illegal program by collecting the continuous and additional information of the illegal users in operation 212.

On the other hand, although being omitted in the method for detecting an illegal user in accordance with an embodiment of the present invention, after checking whether or not the illegal user is on the basis of the game log data of the each illegal user registered in the candidate group, the verification of the method for recognition may be performed on the basis of the checking.

In accordance with the above-described apparatus and method for detecting an illegal user, it is possible to cope with the change of a game bot or auto program, and not only to securely perform detecting in an unknown game bot or auto program but also to continuously and minutely track the game bot or auto program by detecting an illegal user using the difference of unique characteristics between a normal user and the game bot or auto program.

The combinations of the each block of the block diagram and each step of the flow chart may be performed by computer program instructions. Because the computer program instructions may be loaded in a general purpose computer, a special purpose computer, or other processor of programmable data processing equipment, the instructions performed through the computer or other processor of programmable data processing equipment may generate the means performing functions described in the each block of the block diagram and each step of the flow chart. Because the computer program instructions may be stored in the computer available memory or computer readable memory which is capable of intending to a computer or other programmable data processing equipment in order to embody a function in a specific way, the instructions stored in the computer available memory or computer readable may produce a manufacture item involving the instruction means performing functions described in the each block of the block diagram and each step of the flow chart. Because the computer program instructions may be loaded on the computer or other programmable data processing equipment, the instructions performing the computer or programmable data processing equipment may provide the steps to execute the functions described in the each block of the block diagram and each step of the flow chart by a series of operation steps being performed on the computer or programmable data processing equipment, thereby a process executed by a computer being generated.

Further, each block or each step may represent a module, a segment, or a portion of the code which is including one or more executable instructions for executing specified logical function(s). Further, in several alternative embodiments, it is necessary to note that the functions mentioned in blocks or steps may occur out of order. For example, two blocks or steps shown in series may be practically performed simultaneously, or may be performed in reverse order according to functions.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. An apparatus for detecting an illegal user, comprising:
a user characteristics analysis unit configured to analyze difference of unique characteristics between an illegal program and a normal user;
a recognition method determination unit configured to determine a recognition method for recognizing the illegal program on the basis of the difference of the unique characteristics; and
an illegal user detection unit configured to detect the illegal user using the illegal program within a game by the recognition method.

2. The apparatus of claim 1, wherein the user characteristics analysis unit analyzes the difference of the unique characteristics on the basis of the characteristics of the illegal program and a game log data of the normal user.

3. The apparatus of claim 1, wherein the illegal user detection unit extracts a user on the basis of the recognition method and registers the extracted user in a candidate group, and detects the illegal user using the illegal program within the candidate group on the basis of the game log data of the user within the candidate group and the recognition method.

4. The apparatus of claim 3, wherein the illegal user detection unit further comprising:
a verification unit configured to determine whether each user uses an illegal program based on the game log data of the user within the candidate group and then perform verification of the recognition method on the basis of the determination result.

5. The apparatus of claim 1, further comprising a detection result responding unit configured to perform analysis and reporting of the game log data of the detected illegal user.

6. The apparatus of claim 1, further comprising a detection result tracking unit configured to track the illegal user through collecting the game log data of the detected illegal user

7. The apparatus of claim 1, further comprising a verification unit configured to perform verification of the recognition method using a predetermined reference data

8. A method for detecting an illegal user, comprising:
analyzing difference of unique characteristics between a user using an illegal program and a normal user;
determining a recognition method for recognizing the illegal user on the basis of the difference of the unique characteristics; and
detecting the illegal user using the illegal program within a game on the basis of the determined recognition method.

9. The method of claim 8, wherein said analyzing difference of unique characteristics includes:
after obtaining unique characteristics information of the normal user and a user using the illegal program on the basis of a game log data of the normal user and the user using the illegal program, analyzing the difference of the unique characteristics using the obtained unique characteristics information.

10. The method of claim 8, wherein said detecting the illegal user includes:
extracting a user on the basis of the recognition method and then registering the extracted user in a candidate group; and
detecting the illegal user using the illegal program within the candidate group on the basis of the game log data of the user within the candidate group and the recognition method.

11. The method of claim 10, further comprising:
determining whether each user uses an illegal program is on the basis of the game log data of the user registered in the candidate group, and then performing verifying the recognition method on the basis of the determination result.

12. The method of claim 8, further comprising:
analyzing and reporting the game log data of the detected illegal user.

13. The method of claim 8, further comprising:
performing tracking the illegal user through collecting the log data of the illegal user.

14. The method of claim 8, further comprising:
performing verifying the recognition method on the basis of the predetermined reference data, and
wherein said detecting the illegal user using the illegal program is performed such that the illegal user is detected on the basis of the verified recognition method.
